(19) United States
(12) Patent Application Publication
(10) Pub. No.: US 2017/0243168 A1
(43) Pub. Date: Aug. 24, 2017

(54) COMPUTER IMPLEMENTED SYSTEM AND METHOD FOR AUTOMATICALLY AGGREGATING, ANALYZING, AND IDENTIFYING RETIREMENT PLANS FOR PLURALITY OF USERS

(71) Applicant: Congruent Solutions PVT. LTD., Chennai (IN)

(72) Inventor: Rajagopal Sitaram, Chennai (IN)

(21) Appl. No.: 15/584,811

(22) Filed: May 2, 2017

Related U.S. Application Data
(63) Continuation-in-part of application No. 14/194,921, filed on Mar. 3, 2014.
Application No. 14/194,921 is a continuation-in-part of application No. 13/398,048, filed on Feb. 16, 2012, now abandoned.

(30) Foreign Application Priority Data
Feb. 17, 2011 (IN) 454/CHE/2011

(51) Int. Cl. G06Q 10/10; H04L 29/06; G06Q 40/06

(52) U.S. Cl. CPC G06Q 10/1057; G06Q 40/06; H04L 63/083; H04L 63/105

(57) ABSTRACT

A computer implemented system for automatically aggregating, analyzing, and identifying retirement plans for a plurality of users has been disclosed. The system includes a database adapted to store at least authentication credentials and payroll information corresponding to users. The system includes a configuration sub-system adapted to configure the retirement plans based on pre-defined rules. The retirement plans are offered to users subsequent to determining, based on the payroll information corresponding to users, whether the users are eligible for a retirement plan. The users who have been identified as eligible are automatically enrolled onto the retirement plan via an enrollment module. The system also enables the users to initiate investment transfers between various plans, reallocation of investments within the same plan and rebalancing of investments within the same plan. The system also allows the plan sponsor/administrator to timely rectify exceptions if any using a user interface.

### CROSS REFERENCE TO RELATED APPLICATIONS

This application is a continuation-in-part (CIP) of U.S. patent application Ser. No. 14/194,921, filed on Mar. 3, 2014, the disclosure of which is incorporated by reference herein.

### FIELD OF THE DISCLOSURE

The present disclosure relates to the field of retirement plans. Particularly, this disclosure relates to the field of data processing system for efficient gathering of information, processing of information to create data and rectification and dissemination of data relating to retirement plans.

### BACKGROUND

Certain percentage of the total workforce retires every year and a substantial number of people inch closer to retirement with passage of every year. Professionals tend to enroll into a retirement plan for receiving future benefits, for example saving money for their old age requirements. Most working professionals tend to adopt an aggressive approach towards obtaining retirement benefit plans when they are on the verge of taking a retirement from their professional careers.

When an employer makes an annual contribution for a particular employee under a defined retirement contribution plan, the retirement solutions provider initiates the processing of a retirement plan. Normally the process of obtaining a retirement plan includes a number of procedural steps which are carried out by the retirement solution provider.

Given below are some of the factors that are responsible for making the task of gathering, analysis, aggregation, rectification and dissemination of data cumbersome and time consuming:

1. Lack of process automation: Lack or absence of process automation leads to decreased productivity. For example, the process of enrolling employees for a new retirement plan, employee registration can be carried out in two ways: Eligible employees can be either asked to register themselves to the newly formed retirement plan or the retirement plan provider or sponsors (designated employees of a sponsoring organization) can choose to upload a single file with the necessary details of all eligible participants. Further, manually filling data related to employee in the retirement planning system increases dependence on manual resources and is prone to errors.

2. Lack of integration with other software products and services: Lack of integration and synchronization measures can render a system to be ineffective and inefficient. A retirement planning system is required to work in close synchronization with other products/systems that are already available at the consumer's end. Absence of synchronization and integration features will prevent the integration of the retirement planning system with the existing systems thereby rendering it ineffective.

3. Lack of customization: Customizing the business rules underlying the implementation of any currently known retirement planning systems is an arduous task for the end users. Most conventionally known retirement planning systems do not allow the users to easily customize the system as per their needs.

4. Inability to handle large volume implementations: As the number of participants increases, the time taken by the conventional retirement planning system for processing data and processes to get executed can increase exponentially. The retirement planning system must incorporate performance enhancement functionalities that can handle large volumes of information without sacrificing on time. Inability to handle larger volumes of data might render a retirement planning system to be inefficient.

5. Lack of role-based access control rights: Prior art provides for retirement planning systems which fail to provide role based access rights to the users of the retirement planning system. Lack of role based access rights makes privileged data available to even those users who would not require the privileged data for the purpose of carrying out their work.

6. Lack of dashboard based approach: A major feature unavailable in products available in today's market is the ability to get a cumulative review/or analytics at one consolidated place i.e. on the user dashboard section. The retirement planning system, in order to be efficient and effective in providing the services needs to address this issue. After logging into the software system, the users should be able to see a list of things-to-do that are organized in the order of priority. Additionally, the users should also be allowed to directly navigate to the pages that host the relevant task. The inclusion of such a feature would save time and effort that are currently spent in navigating (sometimes through complex flows) through different pages before finally arriving at the target destination page.

7. Long waiting time: The prolonged waiting time for error generation and rectification in the primitive retirement planning systems, makes them more tedious and time consuming. This is because of the long waiting time for processing the subsequent jobs in the queue/batches and further queuing of new jobs which results in a huge backlog. As per the old system, a file containing the user information is uploaded into the database. The validation rules are applied on the data. If there exist any exceptions or errors, a report is generated which is communicated to the plan sponsors/administrators. Once corrected, the file is re-uploaded into the database. Further, to implement a system which is not able to process it's backlogs and update the database timely proves to be very expensive given today's scenario where every second counts.

A number of prior arts have been identified that claim to overcome one or more of the disadvantages mentioned above.

For example, United States Patent Application Publication No. 20060080200 discloses a data management system to electronically provide benefit plan information to the participants. While, the disclosure takes into consideration the different modules that are required to run an electronically controlled benefit plan administration, it stays silent on the need and implementation of quicker error/exception rectification. Also, while the disclosure identifies the sources of error generation, it fails to disclose steps/preventive measures to be taken in order to avoid error propagation.

United States Patent Application Publication No. 20030105692 discloses an interface based retirement funds management system. While, the disclosure covers the major requirements needed for implementing an interface based retirement fund management system, it stays silent about the process needed to expedite the error/exception correction. Also, though the disclosure mentions about the use of corrections/adjustment panels to ensure correctness of information, it fails to provide any explanations to automate and expedite the error/exception correction process.

Therefore, there is felt a need to provide a computer implemented system for automatically aggregating, analyzing, and identifying retirement plans for a plurality of users, that limits the aforementioned drawbacks.

### OBJECTS

Some of the objects of the present disclosure, which at least one embodiment herein satisfies are as follows:

It is an object of the present disclosure to provide a system that implements a web based self-service platform.

Another object of the present disclosure is to provide a system that captures the necessary information at the source without losing control over the process of capturing the information.

Yet another object of the present disclosure is to provide a system that abstains from stitching the individual data sets together.

Still a further object of the present disclosure is to provide a system that is platform independent.

Another object of the present disclosure is to provide a system that performs a real time computation.

Yet another object of the present disclosure is to provide a system that incorporates a dashboard based approach.

Still another object of the present disclosure is to provide a system that provides customizable plan templates and business work flow structures.

Another object of the present disclosure is to provide a system that offers services which can be deployed at separate, remotely located servers.

Yet another object of the present disclosure is to provide a system that ensures data concurrency by isolating the transactions performed on the stored data.

Still another object of the present disclosure is to provide a system that offers services which greatly reduce the time required for exception identification and rectification.

Another object of the present disclosure is to provide a system that offers services which are time saving.

Other objects and advantages of the present disclosure will be more apparent from the following description when read in conjunction with the accompanying figures, which are not intended to limit the scope of the present disclosure.

### SUMMARY

The present disclosure envisages a computer implemented system for automatically aggregating, analyzing, and identifying retirement plans for a plurality of users. The system includes a memory, a processor, a payroll module, a data collection unit, a configuration sub-system, a file processor, a database, a profile creator, a verification sub-system, an exception-management sub-system, a data-segregation sub-system, a correction sub-system, an eligibility module, an enrollment module, and a transfer sub-system.

The memory stores a set of predetermined rules and validation rules. The processor cooperates with the memory to receive the set of predetermined rules, and generate a set of processing commands. The payroll module receives payroll information corresponding to the plurality of user. Further, the data collection unit, under the set of processing commands, receives a plurality of retirement plans from a plurality of third party vendors. The configuration sub-system, under the set of processing commands, receives the plurality of retirement plans and generates retirement plan eligibility rules corresponding to the retirement plans. The file processor, under the set of processing commands, cooperates with the payroll module to receive the payroll information. The file processor further includes an analyzer that analyzes and identifies the different information from the payroll information to generate analyzed payroll information; a formatting module that receives the analyzed payroll information and generates formatted payroll information; and a conversion module that converts the formatted payroll information to converted payroll information. Furthermore, the database, under the set of processing commands, cooperates with the file processor, and the configuration sub-system, and stores the converted payroll information, the plurality of retirement plans and the corresponding retirement plan rules. The profile creator, under the set of processing commands, receives the converted payroll information and creates a profile corresponding to each user. The verification sub-system, under the set of processing commands, verifies the plurality of profiles based on the validation rules, and an exception-management sub-system then identifies exceptions in the profiles, wherein the exceptions include profiles having erroneous entries and which deviate from the validation rules. The data-segregation sub-system, under the set of processing commands, segregates the profiles having the exceptions from the profiles without exceptions. The correction sub-system, under the set of processing commands, corrects the profiles having exceptions and direct rectified profiles to the exception-management sub-system. The eligibility module, under the set of processing commands, cooperate with the database and the profile creator to receive the retirement plan eligibility rules corresponding to the retirement plans and the profile corresponding to each user, respectively, and identifies and list eligible users, for being enrolled in at least one retirement plan based on the retirement plan rules, the eligibility module further sends a notification to the listed eligible users inviting them to get enrolled into the retirement plan. The enrollment module, under the set of processing commands, receives the listed users from the eligibility module and enrolls the listed users into at least one retirement plan. The transfer sub-system, under the set of processing commands, receives the enrolled users from the enrollment module and enables enrolled users to initiate investment transfer of investments between various plans, reallocation of investments within the same plan and, rebalancing of investments within the same plan.

In an embodiment, the system includes an updating module that periodically updates the profiles corresponding to the users.

In one embodiment, the eligibility module generates and interlinks summary reports and detailed reports.

In another embodiment, the enrollment module transmits a personalized enrollment confirmation to the users enrolled in the at least one retirement plans.

In another embodiment, the system includes a user interface that displays the items selected from the group consisting of at least payroll profiles, beneficiary lists, user information, user account summary, investment details, transaction history, retirement plan details, contribution details, retirement plan wise investment details and performance of the investment for a particular plan.

In yet another embodiment, the system includes a vesting computation module that computes the vesting amount using a vesting multiplier.

In another embodiment, the system includes a loan computation module that computes loan amount based on the payroll information.

In another embodiment, the system includes an integration layer that interface external servers with the database.

The present disclosure also envisages a computer implemented method for automatically aggregating, analyzing, and identifying retirement plans for a plurality of users, the method includes the following steps:
storing, in a memory, a set of predetermined rules and validation rules;
receiving, by a processor, the set of predetermined rules and generating a set of processing commands;
receiving, by a payroll module, payroll information corresponding to the plurality of user;
receiving, by a data collection unit, a plurality of retirement plans from a plurality of third party vendors;
receiving, by a configuration sub-system, the plurality of retirement plans and generating retirement plan eligibility rules corresponding to the retirement plans;
analyzing and identifying, by an analyzer, the different information from the payroll information to generate analyzed payroll information;
receiving, by a formatting module, the analyzed payroll information and generating formatted payroll information;
converting, by a conversion module, the formatted payroll information to converted payroll information;
storing, in a database, the converted payroll information, the plurality of retirement plans and the corresponding retirement plan rules;
receiving, by a profile creator, the converted payroll information and creating a profile corresponding to each user;
verifying, by a verification sub-system, the plurality of profiles based on the validation rules;
identifying, by an exception-management sub-system, exceptions in the profiles, wherein the exceptions include profiles having erroneous entries and which deviate from the validation rules;
segregating, by a data-segregation sub-system, the profiles having the exceptions from the profiles without exceptions;
correcting, by a correction sub-system, the profiles having exceptions and direct rectified profiles to the exception-management sub-system;
identifying and listing, by an eligibility module, eligible users, for being enrolled in at least one retirement plan, and sending a notification to the listed eligible users inviting them to get enrolled into the retirement plan;
receiving and enrolling, by an enrollment module, the listed users into at least one retirement plan; and
enabling, by a transfer sub-system, users to initiate investment transfer of investments between various plans, reallocation of investments within the same plan and, rebalancing of investments within the same plan.

### BRIEF DESCRIPTION OF THE ACCOMPANYING DRAWING

The present disclosure will now be described with reference to the non-limiting, accompanying embodiments, in which:

FIG. 1 illustrates a schematic representation depicting interaction of various elements of a system for automatically aggregating, analyzing, and identifying retirement plans for a plurality of users, in accordance with an embodiment of the present disclosure;

FIGS. 2A and 2B illustrate a flowchart corresponding to a method for automatically aggregating, analyzing, and identifying retirement plans for a plurality of users, in accordance with the present disclosure;

FIG. 3 illustrates a schematic representation of the architecture of the system for automatically aggregating, analyzing, and identifying retirement plans for a plurality of users; and

FIG. 4 illustrates a flowchart depicting process steps involved in the system for automatically aggregating, analyzing, and identifying retirement plans for a plurality of users, particularly after exception/error identification and correction.

LIST OF REFERENCE NUMERALS

| Reference Numeral | References |
|---|---|
| 100 | System |
| 10 | memory |
| 12 | processor |
| 14 | payroll module |
| 16 | data collection unit |
| 18 | configuration subsystem |
| 20 | file processor |
| 22 | analyzer |
| 24 | formatting module |
| 26 | conversion module |
| 30 | database |
| 32 | profile creator |
| 34 | verification sub-system |
| 36 | exception-management sub-system |
| 38 | data-segregation sub-system |
| 40 | correction sub-system |
| 42 | eligibility module |
| 44 | enrollment module |
| 46 | transfer sub-system |
| 48 | updating module |
| 50 | user interface |
| 52 | vesting computation module |
| 54 | loan computation module |
| 56 | integration layer |

### DETAILED DESCRIPTION OF THE ACCOMPANYING DRAWING

The present disclosure will now be described with reference to the accompanying drawings which do not limit the scope and ambit of the disclosure. The description provided is purely by way of example and illustration.

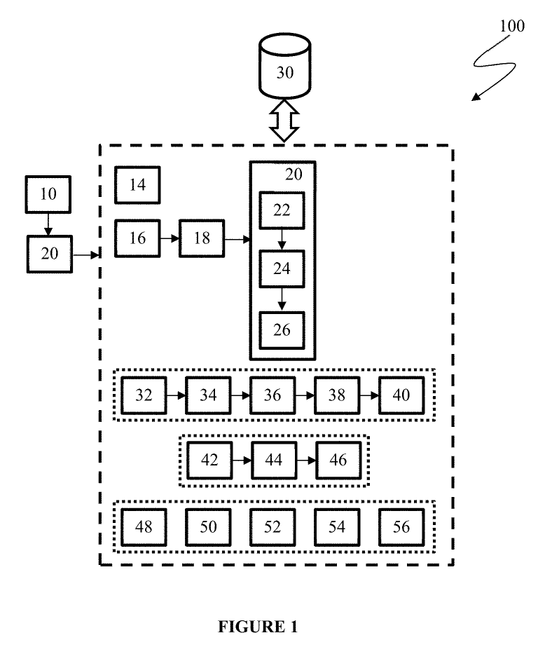

In this specification, the term “user” refers to the users who have enrolled onto at least one retirement plan provided through the system 100. FIG. 1 of the accompanying drawings illustrates a schematic block diagram of the computer implemented system (100) for automatically aggregating, analyzing, and identifying retirement plans for plurality of users. The system (100) comprises a memory (10), a processor (12), a payroll module (14), a data collection unit (16), a configuration sub-system (18), a file processor (20), a database (30), a profile creator (32), a verification sub-system (34), a exception-management sub-system (36), a data-segregation sub-system (38), a correction sub-system (40), an eligibility module (42), an enrollment module (44), and a transfer sub-system (46).

The memory (10) is configured to store a set of predetermined rules and validation rules. The memory (10) may include any computer-readable medium known in the art including, for example, volatile memory, such as static random access memory (SRAM) and dynamic random access memory (DRAM), and/or a non-volatile memory, such as read only memory (ROM), erasable programmable ROM, flash memories, hard disks, optical disks, and magnetic tapes.

The processor (12) is adapted to cooperate with the memory (10) to receive the set of predetermined rules and is configured to generate a set of processing commands. The processor (12) may be implemented as one or more microprocessors, microcomputers, microcontrollers, digital signal processors, central processing units, state machines, logic circuitries, and/or any devices that manipulate signals based on operational instructions. Among other capabilities, the processor (12) is configured to fetch and execute the set of predetermined rules stored in the memory (10) and further configured to generate a set of processing commands. All the modules and units, disclosed in the present disclosure, operate under the set of processing commands.

The payroll module (14) is configured to receive payroll information corresponding to the plurality of user. The payroll module (14) is utilized by retirement plan administrators or sponsors to upload the payroll details corresponding to every user who wishes to obtain a retirement plan. The data entered by retirement plan administrators or sponsors using the payroll module (14) includes, but is not restricted to hours of service of a user, compensations provided by the employer, loan obtained by the user, monetary contributions from the user and the like. The data entered by retirement plan administrators or sponsors is validated by the payroll module (14) using customizable validation rules.

The data collection unit (16), under the set of processing commands, is configured to receive a plurality of retirement plans from a plurality of third party vendors. The data collection unit may be an online data collection unit. The data collection unit (16) may collect data from uploaded files (corresponding to retirement plans), attached files and files identified by a corresponding URI (uniform resource identifier).

The configuration sub-system (18) is adapted to receive the plurality of retirement plans and is configured to generate retirement plan eligibility rules corresponding to the retirement plans.

A pseudo code for configuration sub-system for contributing source list, in accordance with an embodiment of the present disclosure, is now described.

```
#list ContributionSourceRules{
    Display_AllConfiguredContributionSources;
    Check_AbilityToEditAndAdd;
}
# Stop
```

A pseudo code for configuration sub-system for capturing contributing source rules (predefined rules), in accordance with an embodiment of the present disclosure, is now described.

```
#Capture_PlanBasicContributionSourceRules{
    Collect_BasicContributionSourceDetails;
    Validate_BasicContributionSourceDetails;
    Report_AnyExceptionInUI;
    Save_BasicContributionSourceRules;
}
#Stop
```

A pseudo code for configuration sub-system for capturing contributing source rules (additional predefined rules), in accordance with an embodiment of the present disclosure, is now described.

```
#Capture_PlanAdditionalContributionSourceRules{
        Collect_AdditionalContributionSourceDetails;
        Validate_AdditionalContributionSourceDetails;
        Report_AnyExceptionInUI;
        Save_BasicAndAdditionalContributionSourceRules;
}
#Stop
```

The file processor (20) is adapted to cooperate with the payroll module (14) to receive the payroll information. The file processor (20) accepts multiple file types such as excel, csv, fixed length, delimited etc. and converts it into the system (100) compatible format, which enables the system to accomplish the file based integration with the third party systems. The file processor (20) comprises an analyzer (22), a formatting module (24) and a conversion module (26). The analyzer (22) is configured to analyze and identify the different information from the payroll information to generate analyzed payroll information. The formatting module (24) is adapted to receive the analyzed payroll information and is configured to generate formatted payroll information. The conversion module (26) is configured to convert the formatted payroll information to converted payroll information. In an embodiment, the file processor (20) is a JSON (JavaScript Object Notation) based file processor.

Table 1 illustrates a comparison of the total-time required for conversion of the files using the conventional DTS approach, the conventional reflection approach, and the JSON based file processor (20), in accordance with the present disclosure. More specifically, Table 1 summarizes the total conversion time using the file processor, the DTS based approach and reflection based approach for converting the files of a number of employees ranging from 50-10000.

TABLE 1
File Processor Metrics (HH:MM:SS.MS)

| | | Total | | Total Time taken |
|---|---|---|---|---|
| | | Time taken | Total Time taken | using File |
| Sr. | Number of | using DTS | using Reflection | Processor based |
| No | Employees | Approach | Approach | Approach |
| 1 | 50 | | 0:00:06 | 00:00.4 |
| 2 | 100 | | 0:00:14 | 00:00.6 |
| 3 | 500 | | 0:01:02 | 00:01.6 |
| 4 | 1000 | | 0:02:21 | 00:02.8 |
| 5 | 5000 | | 0:23:59 | 00:11.6 |
| 6 | 10000 | 0:00:34 | 1:17:46 | 00:34.4 |

It can be inferred from Table 1 that the time required for conversion using the file processor based approach is significantly less compared to the conventional techniques such as DTS and reflection. Further, the file processor (20) accepts multiple file types and formats, whereas the conventional techniques are restricted to single file types and formats. The file processor (20) performs complex data transformations on the received data without manual intervention. The file processor (20) has the ability to scale up and scale out, thereby providing faster processing capabilities across the board. In an embodiment, the JSON based file processor (20) is configured to convert all the files to JSON format, perform data validations and provide the data to the web service to do validation and further processing.

The database (30) is adapted to cooperate with the file processor, and the configuration subsystem. The database (30) is configured to store the converted payroll information, the plurality of retirement plans and the corresponding retirement plan eligibility rules. The converted payroll information, the plurality of retirement plans and the corresponding retirement plan eligibility rules are typically stored in an encrypted format in order to ensure security of the information.

The database (30), in accordance with the present disclosure also stores the information including but not restricted to beneficiary lists corresponding to retirement plans, user information, user account summary, investment details, transaction history, retirement plan details, contribution details, retirement plan wise investment details and performance of the investment for a particular plan. A pseudo code for loading payroll data and employee census data, in accordance with an embodiment of the present disclosure, is now described.

```
#Load_PayrollAndCensusFile{
        Receive_File;
        Validate_FileInProperFormat;
        Report_AnyExceptionInUI;
        Save_PayrollAndCensusFile;
}
#Stop
```

Background Process for Payroll Information and Census Data Verification and Segregation of Clean and Exception Data Records

```
#StartPayrollandCensusVerificationProcess{
  Read_ReceivedFile;
  Check_FormatsAndDataType;
  Check_EmployeeAvailabilityInDataRepository;
  If(EmployeeNotFound->MarkAsException);
  Check_NewEmployeesDataAndVerifyForDuplicates;
  If(DuplicateAreFound->MarkAsException);
  LoopThroughAllRecordsInFile{
    Perform_ReasonabilityCheckOnHoursAndCompensationData;
    If(NotReasonable->MarkAsException);
    Perform_ContributionsReceivedIsInLineWithContributionElections;
    If(NotInLine->MarkAsException);
    Perform_MatchReceivedIsInLineWithPlanRule;
    If(NotInLine->MarkAsException);
    Perform_LoanRepaymentCheck;
    If(NotProper->MarkAsException);
    Perform_AnnualRegulatoryLimitsCheck;
    If(NotWithinLimit->MarkAsException);
    If(NoExceptionForAnEmployee->MarkAsClean);
    Log_AllExceptionForEmployee;
    }
  Save_BothExceptionAndCleanDataWithStatus;
}
#StopPayrollandCensusVerificationProcess
```

A pseudo code for loading payroll information and employee census data, in accordance with an embodiment of the present disclosure, is now described.

```
#list AllPayrollAndCensusFiles{
    Display_AllPayrollAndCensusFiles;
    Display_TheCurrentStateOfFile;
    Check_AbilityToCorrect;
}
# Stop
```

The profile creator (32) is adapted to cooperate with the database (30) to receive the converted payroll information. The profile creator (32) is configured to create a profile corresponding to each user. The profile creator (32) creates individual payroll profiles. The profile creator (32) is further adapted to carry out periodic updates on the created profiles in order to ensure accuracy of data. The profiles created by the profile creator (32) can be transferred on to a remote server using well known methodologies including UI (User Interface) based upload and FTP (File Transfer Protocol) based upload.

The profile creator (32) provides the retirement plan administrator or sponsors with the option of uploading the payroll information on a one on one basis. The retirement plan administrator or sponsors need not have to wait until all the profiles are created. As soon as a profile is created, the profile creator (32) provides the retirement plan administrator or sponsors with the option of uploading the profile onto a remote server. Alternately, the profile creator (32) also provides the retirement plan administrators or sponsors with the option of customizing the format of the payroll profile. The profile creator (32) also takes into consideration certain schedule details including but not restricted to retirement plan start date, retirement plan end date, retirement plan cutoff date and the like while creating the payroll profiles corresponding to users.

The verification sub-system (34) is configured to verify the plurality of profiles based on the validation rules.

The exception-management sub-system (36) is configured to identify exceptions in the profiles, wherein the exceptions include profiles having erroneous entries and which deviate from the validation rules. The exception-management module (36) is adapted to identify exceptions in the profiles generated by the profile creator (32), wherein the exceptions include profiles having erroneous entries and which deviate from the validation rules. A pseudo code for exception-management sub-system (36) for displaying exceptions, in accordance with an embodiment of the present disclosure, is now described:

```
#Display DetailsofTheSelectedPayrollAndCensusFile{
    Display_SummmaryInformation;
    Display_Records(AllOrExceptionsOrClean);
    If(Exception->Display_ErrorLog);
}
# Stop
```

The data-segregation sub-system (38) is configured to segregate the profiles having the exceptions from the profiles without exceptions. The data-segregation sub-system (38) separates the items which carry exceptions/errors from those that do not. The advantage of doing so is to forward the data that do not carry exceptions for further processing. With fluctuating market prices, the timing for buying and selling goods is of key essence. Hence, in one embodiment the data items which are exception free are released, forwarded for further trading.

The correction sub-system (40) is configured to correct the profiles having exceptions and direct rectified profiles to the exception-management sub-system (36). The correction sub-system (40) gives the plan sponsor/administrator the opportunity to correct the values which are identified as exceptions by the validation rules. The corrections are implemented on a real time feedback displayed on a user interface (50). A pseudo code for exception-management sub-system (36) for displaying exceptions, in accordance with an embodiment of the present disclosure, is now described:

```
#DisplayAndCorrectEceptions{
      Display_DetailsOfSelectedEmployee;
      If(RecordHasExceptions->ColorCodeTab);
          DisplayExceptionDataAndCorrectValues;
      Capture_Corrections;
      If(AcceptAsIsSelectedForCertainDataPoint->
      MarkThatEceptionAsClean);
      OnSaveAndCorrectLater->{
          Initiate_PayrollVerificationProcess;
          Mark_EceptionsAsAppropriate;
          Save_AllChanges;
}
      OnSubmit->{
      InitiatePayrollVerificationProcess;
      If(ExceptionContinues->
          Mark_EceptionAsAppropriate;
          Go_BackToTopAndRepeatProcess;)
      If(NoEceptions->
          Mark_RecordAsClean;
          Mark_AllLoggedErrorsAsCorrected;)
      GoBackToPriorScreen;
}
#Stop
```

The eligibility module (42) is adapted to cooperate with the database (30) and the profile creator (32) to receive the retirement plan eligibility rules corresponding to the retirement plans and the profiles corresponding to each user. The eligibility module (42) is configured to identify and list eligible users, for being enrolled in at least one retirement plan based on the retirement plan eligibility rules. Further, the eligibility module (42) is adapted to send a notification to the listed eligible users inviting them to get enrolled into the retirement plan.

The eligibility module (42) provides the option of sending either a group invite thereby inviting all the eligible users through a single invitation or sending separate invitations to individual users. The eligibility module (42), in accordance with the present disclosure is further adapted to generate summary reports and detailed reports wherein the summary reports created by the eligibility module (42) include at least the payroll details corresponding to eligible users. The summary reports created by the eligibility module (42) are linked with detailed reports which contain detailed information about the user and the retirement plans the user has enrolled onto.

A pseudo code for listing retirement plan eligibility rules, in accordance with an embodiment of the present disclosure, is now described.

```
#list EligibilityRules{
      Display_AllEligibilityrules;
      Check_AbilityToEdit;
      }
      # Stop
```

A pseudo code for capturing retirement plan eligibility rules, in accordance with an embodiment of the present disclosure, is now described.

```
#Capture_PlanBasicEligibilityRules{
        Collect_BasicEligibilityDetails;
        Validate_BasicEligibilityDetails;
        Report_AnyExceptionInUI;
        Save_BasicEligibilityRules;
    }
    #Stop
```

A pseudo code for capturing additional retirement plan eligibility rules, in accordance with an embodiment of the present disclosure, is now described.

```
#Capture_PlanAdditionalEligibilityRules{
        Collect_AdditionalEligibilityDetails;
        Validate_AdditionalEligibilityDetails;
        Report_AnyExceptionInUI;
        Save_BasicAndAdditionalEligibilityRules;
}
#Stop
```

A pseudo code for collecting the retirement plan eligibility schedule details, in accordance with an embodiment of the present disclosure, is now described.

```
#Capture_ScheduleForEligibilityRun{
Collect_EligibilityScheduleDetails;
        Choose_FrequencyOptions;
        Choose_ProcessDateOption;
// (Varies based on the Frequency. Details here are for weekly option)
        Choose_Time;
        Choose_AllOtherParameters;
Validate_Choices;
Report_AnyEceptionInUI;
Save_ScheduleForEligibilityRun;
}
#Stop
#StartScheduledEligibilityRun
CheckPlanEligibilityScheduleConfiguration
IfTimeForNextRun{
        Initiate_EligibilityProcess;
}
#StopScheduledEligibilityRun
```

Eligibility Summary and Detailed reports are generated after every eligibility schedule run.

A pseudo code for background retirement plan eligibility process which is triggered based on the schedule set for the plan or triggered anytime by the plan administrator or the sponsor, in accordance with an embodiment of the present disclosure, is now described.

```
#StartEligibilityProcess{
Collect_PlanEligibilityRulesForThePlan;
Get_AllEmployeesDetailsForTheCompany;
CASE ->AgeRule;
    Compute_AgeOfEmployees;
CASE->ServiceRule;
    If(Elapsed_Time->Compute_ElapsedTimeFromDateOfHire);
    If(Actual_Hours->
    Compute_TotalHoursWorkedForComputationPeriod);
    If(Equivalency->Compute_HoursBasedOnDefaultHours);
    Check_AdditionalEligibilityRulesAgainstAllEmployees;
    Filter_EmployeesOfExcludedGroups;
    Select_EmployeesOfIncludedGroups;
If(Meets_EligibilityRules->Mark_EmployeesEligibilityStatusAsEligible);
If(NotMeets_EligibilityRules->
Mark_EmployeesEligibilityStatusAsInEligible);
}
#StopEligibilityProcess
```

The enrollment module (44) is adapted to cooperate with the eligibility module (42) to receive the listed users and is configured to enroll the listed users into at least one retirement plan. The enrollment module (44) provides the identified and listed users with the option of enrolling to the available retirement plans. The users who enroll to a particular retirement plan using the enrollment module (44) are treated as participants in the retirement plan. The enrollment module (44) also provides the users with the facility of performing certain operations including, but not restricted to setting up the access password, entering the personal information, confirming the contribution rate, selecting the amount of investment and the like.

The enrollment module (44) also provides the retirement plan administrators or sponsors with the option of initiating automatic enrollment of eligible users identified and listed by the eligibility module (42). The enrollment module (44) automatically enrolls those eligible users who by themselves have not enrolled to any of the retirement plans (users not having enrolled onto any of the available retirement plans) within the time period available for enrollment. The automatic enrollment carried out by the enrollment module (44) is administered by the retirement plan administrator or sponsors. The enrollment module (44) also sends personalized enrollment confirmations to all the users who get enrolled to the plan either on their own or through the process of automatic enrollment. A pseudo code for automatically enrolling the eligible users in retirement plan, in accordance with an embodiment of the present disclosure, is now described.

```
#Capture_AutoEnrollmentBasicInfo{
    Collect_BasicInfo;
    Validate_BasicInfo;
    Report_AnyEceptionInUI;
    Save_BasicInfo;
  }
#Proceed_Step2
#Capture_AutoEnrollment DefaultContribution {
    Display_ContributionSourcesConfiguredInPlan;
    Collect_AutoEnrollmentDefaultContributions;
    Validate_ AutoEnrollmentDefaultContributions;
    Report_AnyEceptionInUI;
    Save_ AutoEnrollmentDefaultContributions;
}
#Proceed_Step3
#Capture_AutoEnrollmentInvestmentOptions {
Collect_AutoEnrollmentInvestmentPreference;
If(InvestmentPreference_Varies->ChooseMultipleInvestmentPreferences);
      Validate_ AutoEnrollmentInvestmentPreferences;
      Report_AnyEceptionInUI;
      Save_ AutoEnrollmentInvestmentPreferences;
  }
  #Proceed_Step4
  #Capture_AutoEnrollmentInvestmentAllocations {
      Display_AutoEnrollmentInvestmentsForContributionSources;
      Collect_AutoEnrollmentInvestmentAllocationsForEachContributionSources;
      Validate_AutoEnrollmentInvestmentAllocationsForEachContributionSourcesAddsTo100;
      Report_AnyEceptionInUI;
      Save_ AutoEnrollmentInvestment InvestmentAllocations;
  }
  #Proceed_Step5
  #Capture_AutoEnrollmentFinalConfirmation {
      Display_AutoEnrollmentOptionsChoosenInPriorSteps;
      Collect_AutoEnrollmentEffectiveDate;
      Validate_ AutoEnrollmentEffectiveDate;
      Report_AnyEceptionInUI;
      Save_AutoEnrollmentFinalConfirmation;
}
#Stop_AutoEnrollmentConfiguration
```

A pseudo code for planning enrollment rules, in accordance with an embodiment of the present disclosure, is now described:

```
#Capture_PlanEnrollmentRules{
    Collect_EnrollmentDateRelatedRules;
    Collect_EnrollmentWindowPeriodForAffirmativeAction;
    Repeat_AboveTwoStepsForDifferentEmployeeGroups;
    //This may or may not be required//
    Validate_ EnrollmentDetails;
    Report_AnyEceptionInUI;
    Save_EnrollmentDetails;
}
#Stop_PlanEnrollmentRules
```

A pseudo code for automatic enrollment run, in accordance with an embodiment of the present disclosure, is now described:

```
#CaptureScheduleForAutoEnrollmentRun{
Collect_AutoEnrollmentScheduleDetails;
    Choose_FrequencyOptions;
    Choose_ProcessDateOption; // (Varies based on the
    Frequency. Details here are for weekly option)
    Choose_Time;
    Choose_AllOtherParameters;
    Validate_Choices;
    Report_AnyEceptionInUI;
    Save_ScheduleForAutoEnrollmentRun;
}
#Stop
```

### Timer to Watch and Initiate Scheduled Auto Enrollment

#StartScheduledAutoEnrollmentRun
CheckPlanAutoEnrollmentScheduleConfiguration
IfTimeForNextRun{
Initiate_AutoEnrollmentProcess;
}
#StopScheduledAutoEnrollmentRun

Background Auto Enrollment Process is triggered based on the Auto Enrollment schedule set for the Plan or triggered anytime by the Plan Administrator or the Sponsor.

```
#StartAutoEnrollmentProcess{
    Collect_PlanEnrollmentRulesForThePlan;
    Collect_PlanAutoEnrollmentConfigurationRulesForThePlan;
    Get_AllEligibleButUnenrolledEmployeesForTheCompany;
  LoopThroughAllFilteredEmployees{
    Set_ContributionsBasedonAutoEnrollmentConfiguration;
    Set_InvestmentAllocationsBasedonAutoEnrollmentConfiguration;
    Set_EntryAndEnrollmentDateBasedonPlanEnrollmentRules;
    }
  Mark_EmployeesEnrollmetStatusAsEnrolled);
}
#StopAutoEnrollmentProcess
```

The transfer sub-system (46) is adapted to cooperate with the enrollment module (44) to receive the enrolled users and is configured to enable the enrolled users to initiate investment transfer of investments between various plans, reallocation of investments within the same plan and, rebalancing of investments within the same plan. The transfer sub-system (46) provides the registered users with the option of transferring the money invested on a particular investment option in a particular retirement plan to other investment options provided within the same retirement plan. The transfer of investment is permitted only if the transfer of investments is in compliance with the rules corresponding to the current retirement plan. The user is also provided with an option of either transferring the existing monetary investment to other investment options available within the same retirement plan or reallocating the monetary investment within the existing retirement plan or rebalancing the current investment within the existing retirement plan. A pseudo code for transfer sub-system (46) for displaying transfer option, initiating transfer of investment and rebalancing the investment, in accordance with an embodiment of the present disclosure, is now described:

I. Pseudo Code for Displaying Transfer Option

#Display TrasnferOptionAvailableInPlan{
}
# Stop

II. Pseudo Code for Initiating Transfer of Investment

```
#Request InitiateTransfers{
    Display_SourceInvestmentBalance;
    Accept_TransferOutAndTransferInDetails;
    Validate_TransferInformation;
    Report_AnyExceptionInUI;
    Save_TransferDetails;
}
#Stop
```

III. Pseudo Code for Rebalancing the Investment

```
#Request InitiateRebalance{
    Display_SourceInvestmentBalance;
    Accept_RebalanceDetails;
    Validate_RebalanceInformation;
    Report_AnyExceptionInUI;
    Save_RebalanceDetails;
}
#Stop
```

The system (100), in accordance with the present disclosure further includes an updating module (48). The updating module (48) is configured to periodically update the profiles corresponding to the users. In an embodiment, the retirement plan administrator or sponsor is provided with the option of editing and updating the payroll information corresponding to users. The updating module (48) is also utilized to update at least the payroll information available within the system (100), which includes at least loans obtained by a user, monetary contributions provided by the employer, compensations received by a user, user's access password, personal information, names of beneficiaries, user's and employer's monthly contribution rate, and amount of investment. The user who has enrolled onto a retirement plan is also provided with the option of editing his/her beneficiary list. The user can add or delete beneficiaries from the corresponding beneficiary list. When the payroll information is altered using the updating module (48), an email notification detailing the alterations is automatically sent by the updating module (48) to the concerned user as well as the concerned plan administrator/sponsor. In case if an organization wishes to enroll its employees for a retirement plan, it can do so by uploading a CSV (Comma Separated Value) file which includes relevant but bulk data that corresponds to the entire Workforce of the organization.

The system (100), in accordance with the present disclosure further includes a user interface (50) adapted to display the items selected from the group consisting of at least payroll profiles, beneficiary lists, user information, user account summary, investment details, transaction history, retirement plan details, contribution details, retirement plan wise investment details and performance of the investment for a particular plan.

The user interface (50) communicates with the updating module (48) to receive and display the updated user payroll information. The user interface (50) is also adapted to display the user payroll profile that is generated by the profile creator (32). The user interface (50) is also adapted to display the list of eligible users identified by the eligibility module (42). The user-interface (50) is further adapted to display the summary of the account owned by the user. The account summary displayed by the user interface (50) includes data corresponding to at least investment wise transaction details, source wise transaction details, pending transaction details, account balance details, completed transaction details and performance details corresponding to the investment. The user interface (50) also displays user related information including, but not restricted to user name, designation, user payroll information, user contribution details and investment allocation details. The user interface (50) is further adapted to display the plan summary corresponding to the retirement plan selected by a particular user, which includes the amount invested on the retirement plan.

In accordance with the present disclosure, the user interface (50) of the system displays a dashboard to retirement plan sponsors and administrators. The dashboard is typically displayed on the ‘Home Page’ of respective Plan Sponsors and Administrators. The dashboard contains a plurality of placeholders which in turn hold different types of information (including at least static information and dynamic information). These information sets include but are not restricted to to-do lists, alerts and general information corresponding to retirement plans. The dashboard can also contain dynamic links and information customized according to the needs of plan sponsors/administrators. All the transactions performed on the dashboard are recorded and stored in the form of tables in the database (30). The system (100) makes use of a generic software program which is invoked from all the methods under execution in order to track, record the transactions performed on the dashboard displayed to plan sponsors/administrators.

The system (100), in accordance with the present disclosure further includes a vesting computation module (52). The vesting computation module (52) is configured to compute the vesting amount using a vesting multiplier. The vesting computation module (52) performs complex data processing. The vesting computation module (52) keeps track of the vesting percentages of the users as well as the amount withdrawn from their individual vested balances to arrive at the current vesting balance. The vesting computation module (52) maintains a weighted average multiplier for each user record across each source that has a vesting provision. The weighted average multiplier is updated each time when there is a contribution or withdrawal to/from the source to ensure that the vesting percentage is always reflective of only the un-vested amount and does not lead to a case where the user is able to withdraw more than they are allowed to, and also ensuring that their vested balances do not become negative. The vesting computation module (52) is configured to compute the vesting amount using a vesting multiplier. In an embodiment, the vesting multiplier is computed using the following equation:

$$Vesting Multiplier = \frac{AB * PVM}{AB - WA} - \frac{WA}{AB - WA}$$

Where,

AB:—Account Balance

PVM:—Previous Vesting Multiplier

WA:—Withdrawal amount

Tables 2 and 3 illustrate vesting calculations using conventional methods.

TABLE 2

| | |
|---|---|
| User's Account Balance | $40,000 |
| Vesting Percentage | 60% |
| Vested Balance | $24,000 |

Assuming that there is a withdrawal of $10,000 from the account. Now the calculations will reflect the following:

TABLE 3

| | |
|---|---|
| User's Account Balance | $30,000 |
| Vesting Percentage | 60% |
| Vested Balance | $18,000 |

The vested balance calculation, using conventional methods, does not take into account the fact that $10,000 is taken from the vested balance. The actual vested balance should read $14,000, but the vesting percentage should still be 60%.

Tables 4 and 5 illustrate vesting calculations using the vesting multiplier based approach as disclosed in the present disclosure.

TABLE 4

| | |
|---|---|
| Users Account Balance | $40,000 |
| Vesting Percentage | 60% |
| Vesting Multiplier | 0.6 |
| Vested Balance | $24,000 |

Assume that, there is a withdrawal of $10,000 from the account. Now the calculations will reflect the following:

TABLE 5

| | |
|---|---|
| Users Account Balance | $30,000 |
| Vesting Percentage | 60% |
| Vesting Multiplier | 0.466667 |
| Vested Balance | $14,000 |

The vesting multiplier is calculated using the algorithm given above: as 0.466667, and the vested balance is calculated as $30,000*0.466667=$14,000.

The vesting computation module provides accurate computation of vesting, and updates the vesting after each withdrawal and deposit thereby reducing the requirement of manual intervention to update the vesting. The vesting computation module provides real time computation of vesting that allows all the transactions to happen on a real time basis, ensuring all the users see and work on the exact same data at all times and thereby reducing errors.

The system (100), in accordance with the present disclosure further includes a loan computation module (54). The loan computation module (54) is configured to compute the loan amount based on the payroll information. The loan computation module (54) is configured to compute the loan amount based on the payroll information. The loan computation module (54) employs the following equation for computing the loan amounts. More specifically, the loan computation module (54) computes a payment per period, an interest per period and a principal per period.

$$Payment per period = P * \frac{J}{1 - {( 1 + J )}^{⋀} - N}$$

Where,

P—Principal Amount,

J—Rate of Interest per installment

N—Total Number of Periods or Installments

And for each Periodic Payment,

Interest per period=Principal Balance*J (interest per period)

Principal per period=Payment per period-Interest

The load computation module (54) computes loans online and sets up a workflow for either straight through processing or an approval step. The loan computation module allows upload of the documents at the time of loan processing, thereby reducing the need for paper trails. Further, the loan computation module provides immediate loan approvals based on the information received from the payroll module.

The system (100), in accordance with the present disclosure further includes an integration layer (56). The integration layer (56) is configured to interface external servers with the database (30). The integration layer (56) supports multiple formats of data transfer. Further, the integration layer (56) converts data from one format to another and handles large legacy files. Furthermore, the integration layer (56) provides direct integration with other systems, without any changes. The integration layer (56) provides faster, and real time data exchange. The real time data exchange happens immediately as opposed to batch file based data exchanges that may take many hours to process, depending on the transaction.

In accordance with the present disclosure, the system (100) further includes a notes manager (not shown in figures) which enables the user to make notes for every transaction she/he performs on the system (100). On every webpage displayed on the user interface (50) there is provided a link which invokes a text area with previous notes, if any. The text area is invoked from a master page that acts as a central place where changes to the notes created by users, if any, get registered. Using notes manager, users can add new note as well as update previous notes. All the notes created by the users are stored in the database along with the object ID, user ID and other relevant user information. The notes created by users can either be private or public. Private notes are visible only to the user who created the note, whereas public notes are visible to all the users working on that particular object.

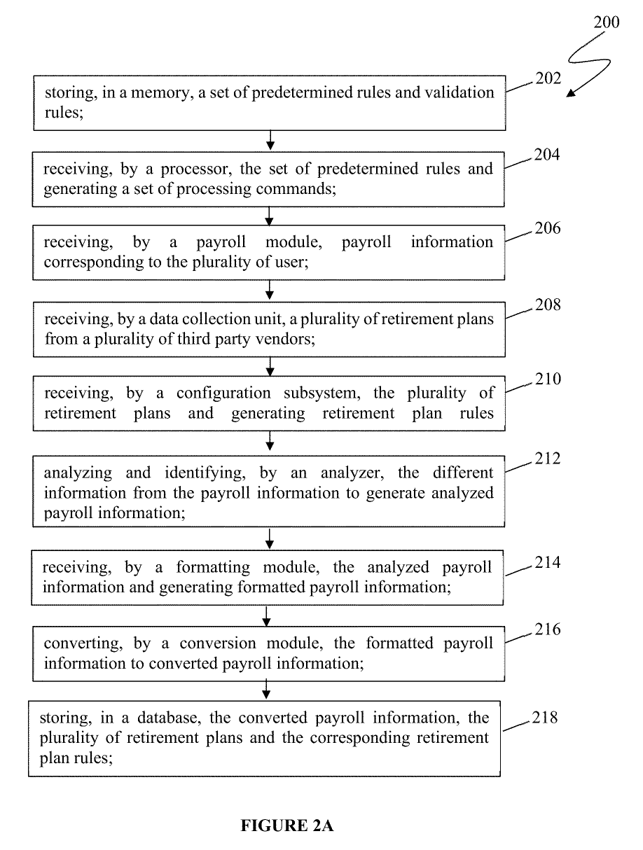

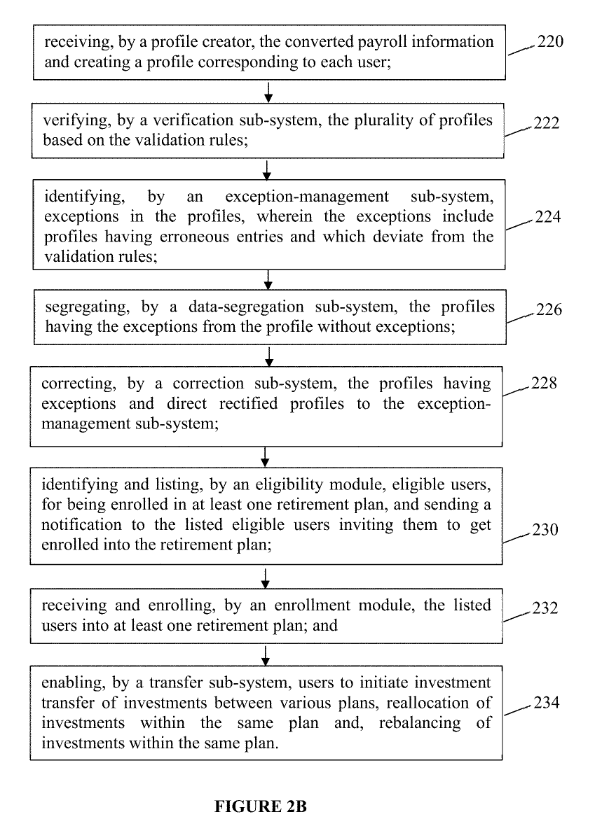

Referring to FIG. 2, there is provided a flowchart 200 detailing the steps involved in the method for automatically aggregating, analyzing, and identifying retirement plans for a plurality of users. The method, in accordance with the present disclosure includes the following steps:
At block 202, storing a set of predetermined rules and validation rules. In an embodiment, the memory (10) stores a set of predetermined rules and validation rules.
At block 204, receiving the set of predetermined rules and generating a set of processing commands. In an embodiment, a processor (12) receives the set of predetermined rules and generates a set of processing commands
At block 206, receiving payroll information corresponding to the plurality of user. In an embodiment, a payroll module (14) receives payroll information corresponding to the plurality of user.
At block 208, receiving a plurality of retirement plans from a plurality of third party vendors. In an embodiment, a data collection unit (16) receives a plurality of retirement plans from a plurality of third party vendors.
At block 210, receiving the plurality of retirement plans and generating retirement plan eligibility rules corresponding to the retirement plans. In an embodiment, a configuration sub-system (18) receives the plurality of retirement plans and generates retirement plan eligibility rules corresponding to the retirement plans.
At block 212, analyzing and identifying the different information from the payroll information to generate analyzed payroll information. In an embodiment, an analyzer (22) analyzes and identifies the different information from the payroll information to generate analyzed payroll information.
At block 214, receiving the analyzed payroll information and generating formatted payroll information. In an embodiment, a formatting module (24) receives the analyzed payroll information and generates formatted payroll information.
At block 216, converting the formatted payroll information to converted payroll information. In an embodiment, a conversion module (26) converts the formatted payroll information to converted payroll information.
At block 218, storing the converted payroll information, the plurality of retirement plans and the corresponding retirement plan rules. In an embodiment, a database (30) stores the converted payroll information, the plurality of retirement plans and the corresponding retirement plan rules.
At block 220, receiving the converted payroll information and creating a profile corresponding to each user. In an embodiment, a profile creator (32) receives the converted payroll information and creates a profile corresponding to each user.
At block 222, verifying the plurality of profiles based on the validation rules. In an embodiment, a verification sub-system (34) verifies the plurality of profiles based on the validation rules.
At block 224, identifying exceptions in the profiles, wherein the exceptions include profiles having erroneous entries and which deviate from the validation rules. In an embodiment, an exception-management sub-system (36) identifies exceptions in the profiles, wherein the exceptions include profiles having erroneous entries and which deviate from the validation rules.
At block 226, segregating the profiles having the exceptions from the profile without exceptions. In an embodiment, a data-segregation sub-system (38) segregates the profiles having the exceptions from the profiles without exceptions.
At block 228, correcting the profiles having exceptions and direct rectified profiles to the exception-management sub-system. In an embodiment, a correction sub-system (40) corrects the profiles having exceptions and direct rectified profiles to the exception-management sub-system.
At block 230, identifying and listing eligible users, for being enrolled in at least one retirement plan, and sending a notification to the listed eligible users inviting them to get enrolled into the retirement plan. In an embodiment, an eligibility module (42) identifies and lists eligible users, that are enrolled in at least one retirement plan, and sends a notification to the listed eligible users inviting them to get enrolled into the retirement plan.
At block 232, receiving and enrolling the listed users into at least one retirement plan. In an embodiment, an enrollment module (44) receives and enrolls the listed users into at least one retirement plan.
At block 234, enabling users to initiate investment transfer of investments between various plans, reallocation of investments within the same plan and, rebalancing of investments within the same plan. In an embodiment, a transfer sub-system (46) enables users to initiate investment transfer of investments between various plans, reallocation of investments within the same plan and, rebalancing of investments within the same plan.

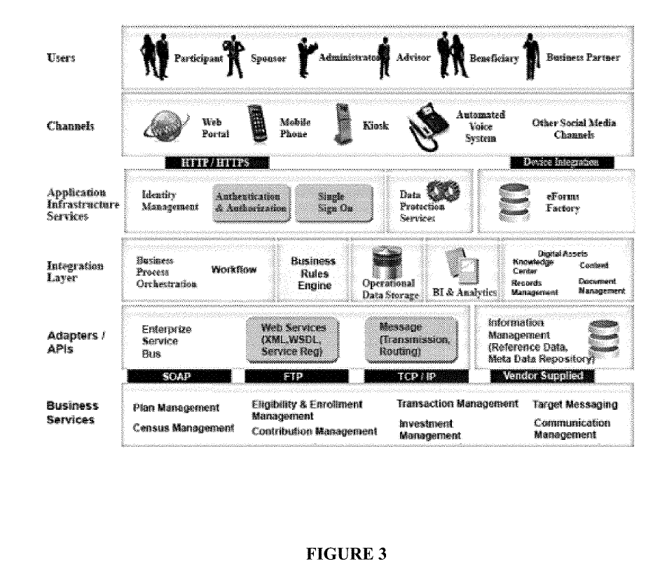

Referring to FIG. 3, there is shown a schematic representation of the components of the system 10 for automatically aggregating, analyzing, and identifying retirement plans for a plurality of users. The “users” column in FIG. 3 denotes the stakeholders of the system (100). The stakeholders of the system (100) include the participant (users who enroll for the retirement plan), sponsors (typically, the employer who offers retirement benefits to their employees), administrator (the organization/individual who takes care of the formalities corresponding to providing retirement benefits to users and administers the plans enrolled onto, by users), advisor (typically, third party advisors who advise users in respect of retirement plans), beneficiary or beneficiaries (typically, the people nominated by the users enrolling onto the retirement plan) and business partner.

The second level, in the architectural overview, as described in FIG. 3 involves the “channels” that could be utilized to access the system (100). In accordance with the present disclosure, all of the aforementioned stakeholders can access the system (100) using either a web portal, a GPRS enabled mobile phone (including iPhone), a computerized kiosk, an automated voice system or any other relevant social media channels. The communication between the aforementioned ‘channels’ and the ‘stakeholders’ takes place via protocols including HTTP (Hypertext Transfer Protocol) or HTTPS (Hypertext Text Transfer Protocol Secured). The third level of the architecture of the system (100) includes “application infrastructure services”, which includes an identity management system. The task of the identity management system is to authenticate and authorize the stakeholders of the system based on the authentication credentials which typically include at least a username and a password.

The application infrastructure component further includes a ‘single sign on’ system which, through device integration enables the stakeholders to log on to the system (100) using a single set of authentication credentials and through a single log-in process across multiple channels of communication which have been described in the “channels” section. The “application infrastructure services” component further includes ‘data protection services’ which ensure the safety of the information (at least the payroll information, retirement plan related information and authentication credentials corresponding to the users) by storing the information in an encrypted format and by preventing unauthorized users from having access to the information. The “application infrastructure services” component further includes an “e-forms factory” which generates all the necessary forms to be utilized by the stakeholders of the system (100). The e-forms factory makes use of the concept of device integration to make the necessary forms available across the multiple channels of communication subsequent to a single log-in process initiated by the stakeholders of the system (100).

The system (100) includes application programming interface (API) comprising a set of computer implemented instructions or routines to accomplish or provide interactions among the various intra as well as inter functionality modules/components. The system (100) needs to communicate with various user groups at various points in time for a multitude of reasons. To enable these interactions, the system (100) has been adapted to enable the stakeholder users to receive information not only from the system but also from other stakeholders, thereby, the enabling API's facilitates inter functionality interactions. The system (100) includes a message center adapted to send internet and intranet messages/notifications such as inbox messages or e-mail. The message center posts the data into a temporary mailing list. The temporary mailing list reads the data posted by the message center and initiates a mailing system to send the mail. Schedules for the mailing service can be adjusted by an administrator.

The system (100) also has the ability to send messages to users through the intranet. To achieve this, the message center posts the data into a specified table which then gets rejected in the relevant stakeholder's home page. The system (100), through the message center provides error messages that make it easy for the users to identify the occurrence of errors, if any and undertake the necessary preventive action. The exception/errors generated by the system (100) are optionally routed to the user in the form of a message. The messages are typically routed in the form of emails. The APIs of the system (100) further include an information management system which holds the reference data required by the stakeholders (data including but not restricted to stakeholder information, information corresponding to occurrence of errors) and also the corresponding metadata.

In accordance with the present disclosure, the architecture of the system (100) as described in FIG. 3 further includes an integration layer. The integration layer includes customized workflows which are managed via a business rules engine which is adapted to determine the course of business workflow of the system (100). The business rules engine is utilized to execute several rules that govern the working of the system (100). For example, the businesses work how engine executes the validation rules for validating the payroll information corresponding to the users.

In accordance with the present disclosure, the architecture of the system (100) further includes a workflow engine. The workflow engine for example, also executes the eligibility rules for identifying the users who are eligible for obtaining a retirement plan. The business rules engine also provides for the business rules to be modified, if necessary. The integration layer further includes an operational data storage which acts as a repository and holds all the necessary business/operational data including but not restricted to user payroll information, retirement plan related information and eligibility information. The integration layer of the system (100) includes an analytical engine that is adapted to receive information/messages/query transmitted by the stakeholders and further adapted to process the stakeholder query/message to transmit the desired information back to the stakeholder. The integration layer of the system (100) includes a digital assets section, a knowledge center, a records-management module which manages the records corresponding to the stakeholders, a document-management module which is adapted to manage all the documents received by/to be provided to the stakeholders of the system (100).

Next component of the system is Application Programmer Interfaces (APIs) which include Web services such as XML (Extensible Markup Language) and WSDL (Web Services Definition Language) which are typically utilized to facilitate communication between the system (100) and the various stakeholders of the system. The APIs of the system further include a messaging system which typically facilitates communication between the system 10 and stakeholders and also the communication between the various stakeholders via transmission/routing of messages.

In FIG. 3, the bottom most layer, includes the component termed as “business services” which involves the working components (described in FIG. 1) of the system (100). The working components described in FIG. 3 are merely representative and it is possible to add/delete the components from the architecture of the system (100) without departing from the scope of the disclosure. The working components of the system (100) include computer protocols such as Simple Object Access Protocol (SOAP), Transmission Control Protocol/Internet Protocol (TCP/IP), File Transfer Protocol (FTP) and a vendor supplied protocols. The SOAP forms the foundation layer of a web service protocol stack, providing a basic messaging framework upon which web services can be built. SOAP can be used over any transport protocol such as Hypertext Transfer Protocol (HTTP), Simple Mail Transfer Protocol (SMTP), Transfer Control Protocol (TCP) and Java Message Service (JMS).

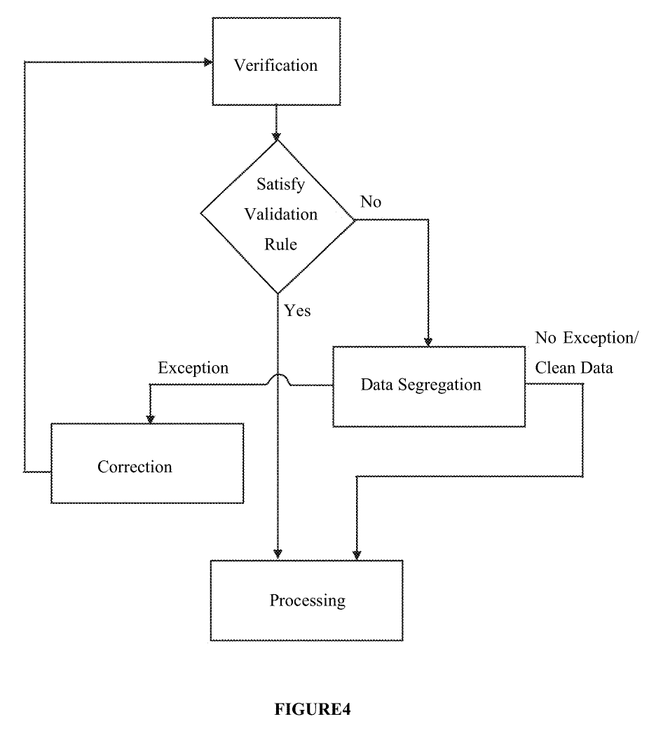

Referring to FIG. 4, the verification sub-system (34) is used to read the data from the database (30) and verify profiles generated by the profile module (32) based on the validation rules. A validation rule is enforced on the data of the profiles. The validation rules are customizable as per the requirement. The validation rules identify exceptions. If no exceptions are found, the dataset of profiles is forwarded for further processing. If the dataset carries exception it is segregated, process represented at the data-segregation sub-system (38). The data-segregation sub-system (38) segregates the dataset into two parts. The first constituting the dataset which carry exceptions, while the second, constituting the dataset which does not carry any exception. The part which carry exceptions are forwarded to the correction sub-system (40).

At the correction sub-system (40), the exceptions are displayed on a user interface (50) and the plan sponsor/administrator is given the provision to correct the exceptions in line with the validation rules. The above mentioned cycle repeats until all the dataset is error free. This procedure avoids the need to hold the entire dataset in lieu of correcting only a few data points. The advantage addressed by the correction sub-system (40) is to reduce the error correction cycle time. Prior technology would require a substantial amount of time, period ranging from one week to a few months to identify and rectify the exceptions. With the above mentioned procedure, this period is reduced to matter of a few minutes and hence saving time and money g. Also, the system greatly reduces the role of human intervention in the process of error/exception correction.

### Technical Advancements

The technical advancements of the present disclosure include, but not limited to, the realization of a system that:
implements a web based self-service platform;
captures the necessary information at the source without losing control over the process of capturing the information;
abstains from stitching the individual data sets together;
is platform independent;
performs a real time computation;
incorporates a dashboard based approach;
provides customizable plan templates and business work flow structures;
offers services which can be deployed at separate, remotely located servers;
ensures data concurrency by isolating the transactions performed on the stored data;
offers services which greatly reduce the time required for exception identification and rectification; and
offers services which are time saving.

Throughout this specification the word “comprise”, or variations such as “comprises” or “comprising”, Will be understood to imply the inclusion of a stated element, integer or step, or group of elements, integers or steps, but not the exclusion of any other element, integer or step, or group of elements, integers or steps.

The use of the expression “at least” or “at least one” suggests the use of one or more elements or ingredients or quantities, as the use may be in the embodiment of the invention to achieve one or more of the desired objects or results.

Any discussion of documents, acts, materials, devices, articles or the like that has been included in this specification is solely for the purpose of providing a context for the invention. It is not to be taken as an admission that any or all of these matters form part of the prior art base or were common general knowledge in the field relevant to the invention as it existed anywhere before the priority date of this application.

The embodiments herein and the various features and advantageous details thereof are explained with reference to the non-limiting embodiments in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the embodiments as described herein.

To overcome the difficulties associated with effective aggregating, analyzing, and distributing information corresponding to retirement plans, the present disclosure proposes a system that treats the steps involved in issuing a retirement plan to the users as a single cycle of steps and provides for an effective collaboration between all the stake holders involved in the process of providing retirement solutions. By treating the steps involved in providing a retirement plan as a single cycle of steps and by ensuring effective collaboration between all the stakeholders involved in the process of providing a retirement solution, the system of the present disclosure provides an efficient, effective and transparent system and method for aggregating, analyzing, rectifying and distributing information corresponding to retirement plans.

1. A computer implemented system for automatically aggregating, analyzing, and identifying retirement plans for a plurality of users, said system comprising:
a memory configured to store a set of predetermined rules and validation rules;
a processor adapted to cooperate with the memory to receive the set of predetermined rules and configured to generate a set of processing commands;
a payroll module, under the set of processing commands, configured to receive payroll information corresponding to the plurality of user;
a data collection unit, under the set of processing commands, configured to receive a plurality of retirement plans from a plurality of third party vendors;
a configuration sub-system, under the set of processing commands, adapted to receive said plurality of retirement plans and configured to generate retirement plan eligibility rules corresponding to the retirement plans;
a file processor, under the set of processing commands, adapted to cooperate with the payroll module to receive the payroll information, said file processor comprises:
an analyzer configured to analyze and identify the different information from the payroll information to generate analyzed payroll information;
a formatting module adapted to receive the analyzed payroll information and configured to generate formatted payroll information; and
a conversion module configured to convert said formatted payroll information to converted payroll information;
a database, under the set of processing commands, adapted to cooperate with the file processor, and the configuration sub-system, and
configured to store the converted payroll information, the plurality of retirement plans and the corresponding retirement plan rules;
a profile creator, under the set of processing commands, adapted to cooperate with the database to receive the converted payroll information and configured to create a profile corresponding to each user;
a verification sub-system, under the set of processing commands, configured to verify said plurality of profiles based on said validation rules;
an exception-management sub-system, under the set of processing commands, configured to identify exceptions in said profiles, wherein said exceptions include profiles having erroneous entries and which deviate from said validation rules;
a data-segregation sub-system, under the set of processing commands, configured to segregate the profiles having said exceptions from the profiles without exceptions;
a correction sub-system, under the set of processing commands, configured to correct said profiles having exceptions and direct rectified profiles to said exception-management sub-system;
an eligibility module, under the set of processing commands, adapted to cooperate with said database and said profile creator to receive the retirement plan eligibility rules corresponding to the retirement plans and the profile corresponding to each user, respectively, and configured to identify and list eligible users, for being enrolled in at least one retirement plan based on the retirement plan rules, said eligibility module further adapted to send a notification to the listed eligible users inviting them to get enrolled into said retirement plan;
an enrollment module, under the set of processing commands, adapted to cooperate with the eligibility module to receive the listed users and configured to enroll the listed users into at least one retirement plan; and
a transfer sub-system, under the set of processing commands, adapted to cooperate with said enrollment module to receive the enrolled users and configured to enable said enrolled users to initiate investment transfer of investments between various plans, reallocation of investments within the same plan and, rebalancing of investments within the same plan.

2. The system as claimed in claim 1, wherein said system further includes an updating module configured to periodically update the profiles corresponding to said users.

3. The system as claimed in claim 1, wherein said eligibility module is further configured to generate and interlink summary reports and detailed reports.

4. The system as claimed in claim 1, wherein said enrollment module is configured to transmit a personalized enrollment confirmation to the users enrolled in the at least one retirement plans.

5. The system as claimed in claim 1, wherein the system includes a user interface adapted to display the items selected from the group consisting of at least payroll profiles, beneficiary lists, user information, user account summary, investment details, transaction history, retirement plan details, contribution details, retirement plan wise investment details and performance of the investment for a particular plan.

6. The system as claimed in claim 1, wherein the system further comprises a vesting computation module configured to compute the vesting amount using a vesting multiplier.

7. The system as claimed in claim 1, wherein the system further comprises a loan computation module configured to compute the loan amount based on the payroll information.

8. The system as claimed in claim 1, wherein the system further comprises an integration layer configured to interface external servers with the database.

9. A computer implemented method for automatically aggregating, analyzing, and identifying retirement plans for a plurality of users, said method comprising the following steps:
storing, in a memory, a set of predetermined rules and validation rules;
receiving, by a processor, the set of predetermined rules and generating a set of processing commands;
receiving, by a payroll module, payroll information corresponding to the plurality of user;
receiving, by a data collection unit, a plurality of retirement plans from a plurality of third party vendors;
receiving, by a configuration sub-system, the plurality of retirement plans and generating retirement plan eligibility rules corresponding to the retirement plans;
analyzing and identifying, by an analyzer, the different information from the payroll information to generate analyzed payroll information;
receiving, by a formatting module, the analyzed payroll information and generating formatted payroll information;
converting, by a conversion module, said formatted payroll information to converted payroll information;
storing, in a database, the converted payroll information, the plurality of retirement plans and the corresponding retirement plan rules;
receiving, by a profile creator, the converted payroll information and creating a profile corresponding to each user;
verifying, by a verification sub-system, the plurality of profiles based on the validation rules;
identifying, by an exception-management sub-system, exceptions in said profiles, wherein said exceptions include profiles having erroneous entries and which deviate from said validation rules;
segregating, by a data-segregation sub-system, the profiles having said exceptions from said profiles without exceptions;
correcting, by a correction sub-system, said profiles having exceptions and direct rectified profiles to said exception-management sub-system;
identifying and listing, by an eligibility module, eligible users, for being enrolled in at least one retirement plan, and sending a notification to the listed eligible users inviting them to get enrolled into said retirement plan;
receiving and enrolling, by an enrollment module, the listed users into at least one retirement plan; and
enabling, by a transfer sub-system, users to initiate investment transfer of investments between various plans, reallocation of investments within the same plan and, rebalancing of investments within the same plan.

10. The method as claimed in claim 9, wherein the method further includes a step of periodically updating, by an updating module, the profiles corresponding to said users.

11. The method as claimed in claim 9, wherein the step of identifying and listing eligible users includes a step of generating and interlinking summary reports and detailed reports.

12. The method as claimed in claim 9, wherein the step of enrolling the listed users includes a step of transmitting a personalized enrollment confirmation to the users enrolled in the at least one retirement plans.

13. The method as claimed in claim 9, wherein the step of enabling users to initiate investment includes a step of displaying by a user interface, the items selected from the group consisting of at least payroll profiles, beneficiary lists, user information, user account summary, investment details, transaction history, retirement plan details, contribution details, retirement plan wise investment details and performance of the investment for a particular plan.

14. The method as claimed in claim 9, wherein the method further includes a step of, computing, by a vesting module, the vesting amount using a vesting multiplier.

15. The method as claimed in claim 9, wherein the method further includes a step of, computing, by a loan computation module, loan amount based on the payroll information.

16. The method as claimed in claim 9, wherein the method further includes a step of, interfacing, by an integration layer, external servers with the database.
